(19) United States
(12) Patent Application Publication
(10) Pub. No.: US 2012/0046416 A1
(43) Pub. Date: Feb. 23, 2012

(54) IMPACT ADDITIVES

(75) Inventors: Rosangela Pirri, Montardon (FR); Jean-Luc Dubois, Millery (FR)

(73) Assignee: Arkema France, Colombes (FR)

(21) Appl. No.: 13/257,030

(22) PCT Filed: Mar. 12, 2010
(86) PCT No.: PCT/FR10/50439

§ 371 Date: Nov. 10, 2011

(30) Foreign Application Priority Data
Mar. 18, 2009 (FR) 0951742

(51) Int. Cl. C08L 27/16; B05D 3/10; B32B 27/08; C08L 33/06; B32B 27/00

(52) U.S. Cl. 525/199; 525/223; 525/55; 428/500; 428/515; 427/214

(57) ABSTRACT

The invention relates to a polymer of core-shell structure containing a core having at least one elastomeric polymer, with a glass transition temperature of less than 25° C., and a shell having at least one polymer, with a glass transition temperature of greater than 25° C., where at least one of the polymers includes (meth)acrylic acid ester monomers containing organic carbon derived from biomass. The present invention also relates to a process for preparing the core-shell polymers and to their use as impact additives, and to a composition containing them.

The present invention relates to polymers of core-shell structure based on (meth)acrylic acid derivatives derived from biomass, to a process for preparing them, to their use as impact additives and to a composition containing them.

It has been known for many years that it is possible to incorporate into polymer materials additives that can afford them mechanical properties, and more particularly impact strength properties. These additives are known as impact modifiers. Some of them are in the form of multilayer fine particles: core-shell structures.

These multilayer particles may have various morphologies. It is possible, for example, to use particles of the “soft-hard” type with an elastomeric nucleus (inner layer) and a rigid shell (outer layer). European patent application EP 1 061 100 A1 describes such particles. It is also possible to use particles of the “hard-soft-hard” type with a core formed from a rigid nucleus and an elastomeric intermediate layer and a rigid shell. Patent application U.S. 2004/0 030 046 A1 describes examples of such particles. It is also possible to use particles of the “soft-hard-soft-hard” type with a core formed, in the following order, from an elastomeric nucleus, a rigid intermediate layer and another elastomeric intermediate layer, and a rigid shell. French patent application FR-A-2 446 296 describes examples of such particles. Thus, the morphology of the impact additive is chosen as a function of the chemical nature of the host polymer matrix and of the properties of the impact additive.

In general, these impact additives are synthesized from (meth)acrylic acid derivatives, irrespective of the morphology of the core-shell structure. Now, the starting materials used for the synthesis, for example methyl methacrylate, which is generally present in a hard layer (either in the shell or in the lower layers of the core) are mainly of petroleum origin or of synthetic origin. The process for synthesizing this monomer thus comprises many sources of emission of CO₂, which have been reported in the literature as being 5600 g/kg of PMMA (polymethyl methacrylate) (Catalysis Today, 99, (2005), 5-14) and consequently contribute toward increasing the greenhouse effect. Given the decrease in worldwide petroleum reserves, the source of these starting materials will gradually diminish. This consideration regarding methyl methacrylate is also valid for other monomers, such as acrylic acid esters, which are also used in the synthesis of impact additives.

Thus, environmental concerns in recent years are pushing in favor of the development of materials that satisfy to the best possible extent the concerns in terms of sustainable development, by especially limiting the supplies of starting materials derived from the petroleum industry for their manufacture.

Starting materials derived from biomass, generally known as biosources or bioresources, can be renewed and generally have a reduced impact on the environment, since they are already functionalized and they require fewer transformation steps.

Since a renewable starting material is an animal or plant, natural resource, whose stock can be reconstituted over a short period on the human timescale, it is necessary for this stock to be able to be renewed as quickly as it is consumed.

Moreover, as they are formed from non-fossil carbon, during their incineration or degradation, the CO₂ derived from these materials does not contribute toward the accumulation of CO₂ in the atmosphere.

The term “biomass” means starting material of plant or animal origin produced naturally. This type of starting material is characterized in that the plant for its growth has consumed atmospheric CO₂ while at the same time producing oxygen. Animals for their growth have, for their part, consumed this plant starting material and have thus assimilated carbon derived from atmospheric CO₂.

Thus, these starting materials derived from biomass require fewer refining and transformation steps, which are very energy-intensive. The production of CO₂ is reduced, and as such they contribute less toward climatic heating. For example, the plant has consumed atmospheric CO₂ at a rate of 44 g of CO₂ per mole of carbon (or per 12 g of carbon) for its growth. Thus, the use of a starting material derived from biomass begins by reducing the amount of atmospheric CO₂. Plant materials have the advantage of being able to be cultured in large amounts, according to demand, throughout the majority of the world, including those produced by algae and microalgae in a marine environment.

It thus appears necessary to have available polymers constituting impact modifiers that are not dependent on starting material of fossil origin. As a result, the aim of the present invention is to satisfy certain concerns in terms of sustainable development.

For these reasons, it is advantageous to propose a polymer of core-shell structure used as an impact modifier, comprising in its structure units derived from starting material originating from biomass.

Other characteristics, aspects, subjects and advantages of the present invention will emerge even more clearly on reading the description and the examples that follow.

One subject of the present invention is thus, firstly, a polymer of core-shell structure comprising:
a core comprising at least one elastomeric polymer, with a glass transition temperature of less than 25° C., preferably less than 0° C., more preferably less than −5° C. and even more preferably less than −25° C., and
a shell comprising at least one polymer, with a glass transition temperature of greater than 25° C., characterized in that at least one of said polymers comprises at least one unit derived from a monomer chosen from an acrylic acid ester, a methacrylic acid ester and a mixture thereof, comprising organic carbon originating from biomass determined according to standard ASTM D6866, and, when it comprises methyl methacrylate, said methyl methacrylate is present in a content of between 1% and 40% by weight relative to the total weight of the polymer.

Unlike materials derived from fossil materials, starting materials derived from biomass contain ¹⁴C in the same proportions as atmospheric CO₂. All the carbon samples taken from living organisms (animals or plants) are in fact a mixture of three isotopes: ¹²C (representing about 98.892%), ¹³C (about 1.108%) and ¹⁴C (traces: 1.2×10⁻¹⁰ %). The ¹⁴C/¹²C ratio of living tissues is identical to that of the atmosphere. in the environment, ¹⁴C exists in two predominant forms: in mineral form, and in organic form, i.e. carbon integrated into organic molecules such as cellulose.

In a living organism, the ¹⁴C/¹²C ratio is kept constant by metabolism, since the carbon is continually exchanged with the environment. Since the proportion of ¹⁴C is constant in the atmosphere, it is likewise constant in the organism, as long as it is alive, since it absorbs this ¹⁴C just as it absorbs the ¹²C. The ¹⁴C/¹²C mean ratio is equal to 1.2×10⁻¹². Carbon-14 is derived from the bombardment of atmospheric nitrogen (14), and oxidizes spontaneously with atmospheric oxygen to give CO₂. In our human history, the ¹⁴CO₂ content has increased after atmospheric nuclear explosions, and has subsequently not ceased to decrease after the stoppage of these tests.

¹²C is stable, i.e. the number of ¹²C atoms in a given sample is constant over time. ¹⁴C, for its part, is radioactive (each gram of carbon of a living being contains enough ¹⁴C isotopes to give 13.6 disintegrations per minute) and the number of such atoms in a sample decreases over time (t) according to the law

n=no exp(−at),
in which:
no is the original number of ¹⁴C atoms (at the death of the creature, animal or plant),
n is the number of ¹⁴C atoms remaining after a time t,
a is the disintegration constant (or radioactive constant); it is linked to the half-life.

The half-life (or period) is the time after which any number of radioactive nuclei or of unstable particles of a given species is reduced by half by disintegration; the half-life T_{1/2} is linked to the disintegration constant a by the formula aT_{1/2}=1n 2. The half-life of ¹⁴C is 5730 years. In 50 000 years, the content of ¹⁴C is less than 0.2% of the initial content and thus becomes difficult to detect. Petroleum products, or natural gas or coal, therefore contain no detectable ¹⁴C.

Given the half-life (T_{1/2}) of ¹⁴C, the content of ¹⁴C is substantially constant from the extraction of the starting materials derived from biomass to the manufacture of the polymer according to the invention, and even up to the end of its use.

Consequently, the presence of ¹⁴C in a material, irrespective of the amount thereof, gives an indication as to the origin of the molecules constituting it, namely that they originate from starting materials derived from biomass and not from fossil materials.

Preferably, the core-shell polymer according to the invention comprises at least 1%, preferably at least 20% and more preferably at least 40% of organic carbon (i.e. of carbon integrated into organic molecules) derived from starting materials originating from biomass according to standard ASTM D6866 relative to the total amount of carbon in the polymer, preferably greater than 60%, and preferentially greater than 80%. This content may be certified by determining the ¹⁴C content according to one of the methods described in standard ASTM D6866-06 (Standard Test Methods for Determining the Biobased Content of Natural Range Materials Using Radiocarbon and Isotope Ratio Mass Spectrometry Analysis).

This standard ASTM D6866-06 comprises three methods for measuring organic carbon derived from starting materials originating from biomass, also known as biobased carbon. These methods compare the data measured on the sample analyzed with the data for a reference sample that is 100% biosourced or derived from biomass, to give a relative percentage of carbon derived from biomass in the sample. The proportions indicated for the polymers of the invention are preferably measured according to the mass spectrometry method or the liquid scintillation spectrometry method described in said standard.

Consequently, the presence of ¹⁴C in a material, irrespective of the amount thereof, gives an indication as to the origin of the molecules constituting it, namely that a certain fraction originates from starting materials derived from biomass and no longer from fossil materials. The measurements performed in the methods described in standard ASTM D6866-06 thus make it possible to distinguish starting monomers or reagents derived from materials originating from biomass from monomers or reagents derived from fossil materials. These measurements serve a test and enable the certification of the content and origin of the carbon in a product.

The polymer of core-shell structure according to the invention is described below.

The core may be an elastomeric single phase, or may consist of several phases or layers of polymer(s). The nonelastomeric and elastomeric polymers of the core may be of chemical nature identical to or different than that of the other polymers of the structure according to the invention. The core represents at least 70% by weight relative to the total weight of the polymer of core-shell structure, preferably at least 80% and more particularly from 65% to 95% by weight.

The term “polymers” means homopolymers and copolymers, the copolymers comprising polymers formed from two or more different monomers, for instance terpolymers. The sequence of the copolymer may be random, block or grafted. The polymers may have any of the known architectures, such as branched, star or comb.

The term “elastomer” means any polymer or copolymer with a glass transition temperature (Tg) of less than 25° C., preferably less than 0° C., more preferably less than −5° C. and even more preferably less than −25° C.

Preferably, the elastomeric polymer has a Tg of between −120 and 0° C. and more particularly between −90 and −10° C.

It is pointed out that the term “between” used in the preceding paragraphs, and also in the rest of the present description, should be understood as including each of the mentioned limits.

The term “shell” means all the layers of the multilayer polymer particle beyond the outermost elastomeric layer of the core.

### The Core

As defined above, the core includes all the layers inside the multilayer particle delimited by the outermost elastomeric layer of said core.
The core may be
an elastomeric single phase,
a rigid layer covered with an elastomeric layer, or
a certain number of rigid and elastomeric layers, the outermost layer necessarily being a layer of elastomeric polymer.

The core may also be formed from a matrix of rigid and elastomeric materials, the assembly being covered with a layer of elastomeric polymer.

At least 30% by weight relative to the total weight of the core is formed from elastomeric polymer, preferably at least 40% by weight and more particularly at least 50% of the core is formed from elastomeric polymer.

Nonlimiting examples of elastomeric polymers that may be present in the core of the core-shell polymer according to the invention are polybutadiene, butadiene-styrene copolymers, polyisoprene, C₂-C₁₈ acrylic polymers, and acrylonitrile, siloxane or silicone copolymers containing elastomers.

According to a first preferred embodiment of the invention, the core is an acrylic polymer or copolymer. The term “acrylic” means that the monomers used to form the elastomeric polymer are acrylic monomers. Preferably, the acrylic polymer comprises at least 80% by weight relative to the total weight of the polymer of acrylic monomer units. Nonlimiting examples of acrylic monomers that are useful in the invention are alkyl acrylates comprising n-propyl acrylate, n-butyl acrylate, amyl acrylate, 2-methylbutyl acrylate, 2-ethylhexyl acrylate, n-hexyl acrylate, n-octyl acrylate, 2-octyl acrylate, 2-propylheptyl acrylate, isooctyl acrylate, n-decyl acrylate, n-dodecyl acrylate and 3,5,5-trimethylhexyl acrylate. More particularly, the preferred acrylic monomers are n-butyl acrylate, n-pentyl acrylate, n-hexyl acrylate, n-heptyl acrylate, 2-ethylhexyl acrylate, n-octyl acrylate, 2-octyl acrylate, isooctyl acrylate, and a mixture thereof. Butyl acrylate, 2-ethylhexyl acrylate, 2-octyl acrylate and n-octyl acrylate are the preferred.

In addition to the acrylic monomers, the elastomeric acrylic polymers may comprise in their structure one or more unsaturated ethylenic monomers comprising up to 20% by weight, preferably up to 15% and more preferentially up to 10% by weight relative to the total weight of the polymer. These nonacrylic monomers are, for example, radical-polymerizable ethylenically unsaturated monomers, and preferably butadiene and styrene, but also isoprene, styrene derivatives, and the like. According to one preferred embodiment, the core of the polymer according to the invention is a copolymer comprising from 85% to 98% and preferably from 90% to 97% by weight of acrylic monomers and from 2% to 15% and preferably from 3% to 10% by weight of butadiene.

The core elastomeric polymer may advantageously comprise small amounts of crosslinking and/or grafting monomers. Preferably, these agents contain at least two double bonds. Examples that may be mentioned include divinylbenzenes, diallyl maleate, polyalcohol (meth)acrylates such as trimethylolpropane triacrylate or trimethacrylate, allyl (meth)acrylate, alkylene glycol di(meth)acrylates containing from 2 to 10 carbon atoms in an alkylene chain, such as ethylene glycol di(meth)acrylate, 1,4-butanediol di(meth)acrylate or 1,6-hexanediol di(meth)acrylate.

The core polymer is formed by emulsion radical polymerization according to the known methods. When the core contains more than one layer, the multilayer core may be synthesized by successive emulsion radical polymerization.

According to a second embodiment of the invention, the core comprises a rigid nucleus, covered with an elastomeric layer as described above in the first embodiment.

The rigid nucleus may be formed from at least one polymer with a Tg of greater than 25° C., preferably between 40 and 150° C. and more preferentially between 60 and 140′C. This polymer may be obtained from one or more ethylenic monomers chosen from C₁-C₈ alkyl acrylates, C₁-C₆ alkyl methacrylates, acrylonitrile, methacrylonitrile, divinylbenzene, α-methylstyrene, para-methylstyrene, chlorostyrene, vinyltoluene, dibromostyrene, tribromostyrene, vinylnaphthalene, iso-propenylnaphthalene, and also (C₉-C₂₀) alkyl (meth)acrylates such as decyl acrylate, lauryl methacrylate, lauryl acrylate, stearyl methacrylate, stearyl acrylate or isobornyl methacrylate. C₁-C₈ alkyl (meth)acrylate monomers are preferred, and especially methyl methacrylate.

The rigid nucleus defined above may advantageously comprise small amounts of crosslinking and/or grafting monomers, as defined previously, in the first embodiment.

According to a third embodiment of the invention, the core comprises a nucleus formed from an elastomeric polymer, covered with a rigid layer as described above, which is itself covered with an elastomeric layer as described above.

### The Shell

The shell of the polymer according to the invention comprises one or more layers of rigid polymers. The term “rigid polymer” means a polymer with a Tg of greater than 25° C., preferably between 40 and 150° C. and more preferentially between 60° C. and 140° C.

According to one preferred embodiment of the invention, the shell polymer comprises one or more ethylenic monomers chosen from C₁-C₈ alkyl (meth)acrylates, acrylonitrile, methacrylonitrile, divinylbenzene, α-methylstyrene, para-methylstyrene, chlorostyrene, vinyltoluene, dibromostyrene, tribromostyrene, vinyl-naphthalene, isopropenylnaphthalene, and also (C₉-C₂₀)alkyl (meth)acrylates, such as decyl acrylate, lauryl methacrylate, lauryl acrylate, stearyl methacrylate, stearyl acrylate or isobornyl methacrylate. Preferably, C₁-C₈ alkyl (meth)acrylate monomers are preferred.

The glass transitions and especially the glass transition temperature (Tg) of the cores and of the core-shell polymers are measured using a machine that enables thermomechanical analysis; this is an RDAII: Rheometrics Dynamic Analyzer from the company Rheometrics. The thermomechanical analysis precisely measures the viscoelastic changes of a sample as a function. of the temperature, the stress or the applied deformation. The machine continuously records the deformation of the sample, under a fixed stress, while it is subjected to a controlled temperature program. The RDAII is composed of the following elements:
A heat regulation chamber or system (in our case the atmosphere during the test is nitrogen gas)
A central control unit
A system for regulating the flow rate and drying of air and nitrogen
A measuring head
A computer system for running the machine and for processing the data
“Sample holder” equipment.
To perform a measurement, the following steps will be followed:
Installation of the equipment (geometry)
Definition of the test parameters: the process will be performed by temperature scanning at a given frequency, the frequency being 1 Hz and the temperature range being between −125° C. and +160° C.
Installation of the sample
Starting of the test.

The results are obtained by plotting, as a function of the temperature, the functions G′ (elastic modulus), G″ (loss modulus) and tangent delta. The glass transition temperatures are obtained at the maximum temperature read on the tangent delta curve when the tangent delta derivative is equal to 0).

### The Core-Shell Polymer

The core-shell polymer according to the invention should comprise in its structure at least one polymer comprising at least one unit derived from a monomer chosen from an acrylic acid ester, a methacrylic acid ester and a mixture thereof, comprising organic carbon originating from biomass determined according to standard ASTM D6866.

The synthesis of methyl methacrylate from biomass may be performed starting with acetone derived from sugar originating, inter alia, from cereal straw fodder, hydrogen cyanide derived from the ammoxidation of methane obtained by fermentation of animal and/or plant organic matter, and methanol originating, inter alia, from the pyrolysis of wood.

Specific details in this respect are described in patent application FR 0853588.

The acrylic acid esters may also comprise organic carbons originating from biomass. It is possible to prepare butyl acrylate or 2-ethylhexyl acrylate by synthesizing these monomers from glycerol derived from plant oils, leading to acrolein, which may be esterified with alcohols, which may themselves originate from biomass. Specific details are described in patent application FR 0855125.

By way of example, n-heptyl acrylate or 2-octyl acrylate are prepared by esterification of acrylic acid or by transesterification, for example, of ethyl acrylate with the corresponding alcohol. 2-Octanol is prepared from starting materials derived from biomass by treating ricinoleic acid (derived from castor oil) with sodium hydroxide (NaOH), followed by a distillation to separate the alcohol from the other by-product, sebacic acid. n-Heptanol is prepared from starting materials derived from biomass by treating ricinoleic acid by steam cracking to obtain heptaldehyde and methyl undecylenate, the heptaldehyde of which is converted into n-heptanol by reduction.

Consequently, the core-shell polymer according to the invention may be formed solely from monomers originating from biomass; which may thus contain 100% thereof.

It may also be formed only in part from monomers originating from biomass, depending on the choice of monomers.

Furthermore, according to the invention, when the core-shell polymer comprises methyl methacrylate, said methyl methacrylate is present in a content of between 1% and 40% by weight relative to the total weight of the polymer.

According to one particular embodiment, the elastomeric polymer present in the core is a styrene/butadiene copolymer. In this event, the polymer constituting the shell is a methacrylate polymer.

According to another particular embodiment, the elastomeric polymer present in the core is an alkyl acrylate/butadiene copolymer or a polymer (homopolymer or copolymer) comprising alkyl acrylate units.

The core-shell polymer according to the invention may also comprise at least one additive.

This additive may be chosen especially from fillers, fibers, dyes, stabilizers, especially UV stabilizers, plasticizers, surfactants, pigments, optical brighteners, antioxidants, anticaking agents, biocides and natural waxes, and mixtures thereof.

Among the fillers, mention may especially be made of silica, carbon black, carbon nanotubes, expanded graphite, titanium oxide or glass beads.

Preferably, this additive will be of natural origin, i.e. satisfying the test of standard ASTM D6866.

The invention also relates to a process for preparing the polymer of core-shell structure, as defined above, comprising:
a) the emulsion radical polymerization of the core-shell polymer from at least two monomers comprising organic carbon derived from biomass determined according to standard ASTM D6866, and
b) the drying of said emulsion of the polymer to form a powder.

Processes for synthesizing one-core/one-shell polymers are described in the literature, for instance in document EP 1 541 603 or in the documents cited in the introduction. These synthetic processes are well known to those skilled in the art.

The additives mentioned above may advantageously be incorporated before the drying step, but also after the drying step. By way of example, the mineral fillers may be incorporated before and/or after drying.

The invention also relates to the use of the core-shell polymer as defined above, as an impact modifier.

A subject of the invention is also a composition comprising:
at least one polymer matrix, and
from 0.5% to 77% by weight, preferably 5% to 70% by weight and more particularly from 2% to 55% by weight, relative to the total weight of a polymer of core-shell structure as defined above.

The polymer matrix may be chosen, in a nonlimiting manner, from poly(vinyl chloride), polyesters, polystyrenes, polycarbonates, polyethylenes, polymethyl methacrylates, (meth)acrylic copolymers, poly(methyl methacrylate-co-ethyl acrylate) thermoplastics, poly-alkylene terephthalates, poly(vinylidene fluoride), poly(vinylidene chloride), semicrystalline polyamides, amorphous polyamides, semicrystalline copolyamides, amorphous copolyamides, polyetheramides, polyester-amides, copolymers of styrene and of acrylonitrile (SAN), and mixtures thereof.

The composition according to the invention may also comprise at least one additive.

This additive may be chosen especially from heat stabilizers; lubricants; flame retardants; organic or mineral pigments; UV stabilizers; antioxidants; anti-static agents; mineral or organic fillers.

Among the fillers, mention may be made especially of calcium carbonates, silica, carbon black, carbon nanotubes, titanium oxide or glass beads.

Preferably, the additives are present in the composition generally in a. content: of from 0.1% to 50% by weight relative to the total weight of the composition.

The composition may be in the form of powder, granules or pellets.

The invention also relates to a process for preparing the composition as defined above. According to this process, the core-shell polymer may be prepared via any method that enables the production of a homogeneous mixture containing the polymer matrix, the core-shell polymer according to the invention, and optionally other additives, such as melt extrusion, compacting or roll blending.

When the polymer matrix is obtained by emulsion polymerization, it may be appropriate to mix the emulsion containing the polymer of core-shell structure according to the invention with the emulsion of the polymer matrix and to treat the resulting emulsion so as more easily to separate the solid product.

The invention also relates to an article obtained by extrusion, coextrusion, hot compression or multi injection using at least one composition as defined above.

The composition according to he invention may be used for forming a structure.

This structure may be monolayer, when it is formed only from the composition according to the invention.

This structure may also be a multilayer structure, when it comprises at least two layers and when at least one of the various layers forming the structure is formed from the composition according to the invention.

The structure, whether it is monolayer or multilayer, may especially be in the form of fibers for example to form a woven or a nonwoven), a film, a sheet, a tube, a hollow body or an injection-molded part.

For example, the films and sheets may he used in a very large number of fields.

### EXAMPLES

### Example 1

Synthesis of a Multilayer Impact Additive with a Hard Core, an Elastomeric or Soft Intermediate Layer and a Hard Shell

The proportions of these 3 layers are 35/45/20 with, for each layer, a refractive index of between 1.460 and 1.500.

### The Compositions for the Layers are:

Layer 1: 74.8/25/0.2 MMA/EA/ALMA
Layer 2: 83.5/15.5/1.0 BA/Sty/ALMA
Layer 3: 95/5 MMA/EA
with the following definitions:
MMA=methyl methacrylate
EA=ethyl acrylate
BA=butyl acrylate
Sty=styrene
ALMA=allyl methacrylate

A monomer mixture representing 14% of the charge of layer 1 is emulsified in an aqueous solution containing potassium dodecylbenzenesulfonate as surfactant and potassium carbonate as of buffer. This emulsion is polymerized using potassium persulfate at high temperature. The rest of the monomer charge of layer 1 is then added to the polymer in emulsion already formed and polymerized using potassium persulfate at high temperature (for example 80° C.) while monitoring the addition, of surfactant to avoid the formation of new particles.

Next, the monomers of layer 2 are added and polymerized using potassium persulfate at high temperature (for example 80° C.) while monitoring the addition of surfactant to avoid the formation of new particles. Next, the monomers of layer 3 are added and polymerized using potassium persulfate at high temperature (80° C.), while monitoring the addition of surfactant to avoid the formation of new particles.

The latex is recovered in the form of powder by atomization.

### Example 2

The polymer of this example is prepared in the same manner as that described in Example 1, except for the monomer composition of layer 1. The composition of layer This 87.8/12.0/0.2 MA/EA/ALMA.

The latex is recovered in the form of powder by atomization.

### Example 3

### Synthesis of a Multilayer Impact Additive with a Soft Core and a Hard Shell

The proportions of the layers are 6.4/73.6/20.

### The Compositions for the Layers are:

Layer 1: 96.9/2.88/0.11/0.11 2EHA/St/BDDA/ALMA Layer 2: 96.9/2.88/0.11/0.11 2EHA/St/BDDA/ALMA
Layer 3: 100 MMA
with the following definitions:
2EHA=2-ethylhexyl acrylate
St=styrene
BDDA=butanediol diacrylate
ALMA=allyl methacrylate

1054 g of demineralized water and 3.66 g of sodium hydrogen phosphate are introduced into a 5-liter reactor. The contents of the reactor are degassed by 3 vacuum-nitrogen cycles. The stirring of the reactor is set at 140 rpm and its temperature is raised to 80° C. Next, a preemulsion of 74.42 g of 2-ethylhexyl acrylate, 2.21 g of styrene, 0.085 g of butanediol diacrylate, 0.084 g of allyl methacrylate, 0.82 g of sodium dodecylsulfosuccinate (75% by weight in water) and 52.75 g of demineralized water is introduced into the reactor. 0.90 g of potassium persulfate dissolved in 21.71 g of water is injected into the reactor. The reactor is maintained at 80° C. for 30 minutes.

Next, 1500 g of preemulsion composed of 855.81 g of 2-ethylhexyl acrylate, 25.46 a of styrene, 0.98 g of butanediol diacrylate, 0.97 g of allyl methacrylate, 9.42 g of sodium dodecylsulfosuccinate (75 wt % in water) and 607.39 g of demineralized water are slowly introduced into the reactor over 126 minutes. In parallel, a solution of 1.32 g of potassium persulfate dissolved in 31.80 g of water is introduced into the reactor over the same period of 126 minutes. At the end of the introductions, a solution of 0.26 g of potassium persulfate dissolved in 5.17 g of water and a solution of 0.38 g of sodium metabisulfite dissolved in 7.33 g of water are injected into the reactor to complete the conversion of the monomers. A conversion of greater than 98% is achieved.

Next, 425.73 g of water are added. The temperature is maintained at 80° C. and the stirring is increased to 160 rpm. 0.47 g of sodium formaldehyde sulfoxylate dissolved in 9.90 g of water is added to the reactor, followed by injection in parallel of 240 g of MMA and 3.6 g of diisopropylbenzene hydroperoxide over a period of one hour. After these additions, the mixture is left for a further 30 minutes at 80° C. Next, a further 0.37 g of sodium metabisulfite dissolved in 8.33 g of water is added. The mixture is maintained for a further minutes at 80° C. It is then cooled to room temperature, the final conversion being 99%.

### Example 4

### Synthesis of a Multilayer Impact Additive with a Soft Core and a Hard Shell

The proportions of the layers are 6.4/73.6/20.

### The Compositions for the Layers are:

Layer 1: 96.9/0.75 2-OA/ALMA
Layer 2: 96.9/0.75 2-OA/ALMA
Layer 3: 100 MMA
with the following definitions:
2-OA=2-octyl acrylate derived from biomass
ALMA=allyl methacrylate.

1054 g of demineralized water and 3.66 g of sodium hydrogen phosphate are introduced into a 5-liter reactor. The contents of the reactor are degassed by 3 vacuum-nitrogen cycles. The stirring of the reactor is set at 140 rpm and its temperature is raised to 80° C. Next, a preemulsion of 76.17 g of 2-octyl acrylate, 0.63 g of allyl methacrylate, 0.82 g of sodium dodecylsulfosuccinate (75% by weight in water) and 52.75 g of demineralized water is introduced into the reactor. 0.90 g of potassium persulfate dissolved in 21.71 g of water is injected into the reactor. The reactor is maintained at 80′C for 30 minutes.

Next, 1500 g of preemulsion composed of 875.94 g of 2-octyl acrylate, 0.97 g of allyl methacrylate, 9.42 q of sodium dodecylsulfosuccinate (75 wt % in water) and 607.39 g of demineralized water are slowly introduced into the reactor over 126 minutes. In parallel, a solution of 1.32 g of potassium persulfate dissolved in 31.80 g of water is introduced into the reactor over the same period of 126 minutes. At the end of the introductions, a solution of 0.26 g of potassium persulfate dissolved in 6.17 g of water and a solution of 0.38 g of sodium metabisulfite dissolved in 7.33 g of water are injected into the reactor to complete the conversion of the monomers. A conversion of greater than 98% is achieved.

Next, a further 425.73 g of water are added. The temperature is maintained at 80° C., and the stirring is increased to 160 rpm. 0.47 g of sodium formaldehyde sulfoxylate dissolved in 9.90 g of water are added to the reactor, and 240 g of MMA and 3.6 g of diisopropyl-benzene hydroperoxide are then injected in parallel over a period of one hour. After these additions, the mixture is left for a further 30 minutes at 80° C. Next, a further 0.37 g of sodium metabisulfite dissolved in 8.33 g of water is added. The mixture is maintained for a further 30 minutes at 80° C. It is then cooled to room temperature, the final conversion being 99%.

1-10. (canceled)

11. A core-shell polymer comprising:
a core comprising at least one elastomeric polymer, having a glass transition temperature of less than 25° C., and
a shell comprising at least one polymer, having a glass transition temperature of greater than 25° C.,
wherein at least one of said polymers comprises at least one monomer selected from an acrylic acid ester, a methacrylic acid ester or a mixture thereof; wherein the monomer comprises organic carbons derived from biomass, wherein when the monomer comprises methyl methacrylate, said methyl methacrylate is present in an amount of between 1% and 40% by weight relative to the total weight of the polymer.

12. The core-shell polymer of claim 11, wherein the core-shell polymer comprises at least 1% of organic carbons derived from starting materials originating from biomass relative to the total amount of carbon in the polymer.

13. The core-shell polymer of claim 11, wherein the core-shell polymer comprises at least 20% of organic carbons derived from starting materials originating from biomass relative to the total amount of carbon in the polymer.

14. The core-shell polymer of claim 11, wherein the elastomeric polymer comprises one or more monomers selected from n-propyl acrylate, n-butyl acrylate, amyl acrylate, 2-methylbutyl acrylate, 2-ethylhexyl acrylate, n-hexyl acrylate, n-octyl acrylate, 2-octyl acrylate, heptylpropyl acrylate, n-decyl acrylate, n-dodecyl acrylate or 3,5,5-trimethylhexyl acrylate.

15. The core-shell polymer of claim 14, wherein the elastomeric polymer comprises one or more monomers selected from butyl acrylate, 2-ethylhexyl acrylate, n-octyl acrylate or 2-octyl acrylate.

16. The core-shell polymer of claim 11 wherein the shell comprises at least one rigid polymer, wherein the rigid polymer comprises one or more ethylenic monomers selected from C₁-C₈ alkyl acrylates, C₁-C₈ alkyl methacrylates, acrylonitrile, methacrylonitrile, divinylbenzene, α-methylstyrene, para-methylstyrene, chlorostyrene, vinyltoluene, dibromostyrene, tribromostyrene, vinylnaphthalene, isopropenylnaphthalene, decyl acrylate, lauryl methacrylate, lauryl acrylate, stearyl methacrylate, stearyl acrylate or isobornyl methacrylate.

17. The core-shell polymer of claim 16, wherein the rigid polymer comprises methyl methacrylate.

18. The core-shell polymer of claim 11, wherein the core comprises a rigid nucleus covered with an elastomeric polymer, wherein the rigid nucleus comprises at least one polymer having a glass transition temperature of greater than 25° C.

19. The core-shell polymer of claim 11, wherein the core comprises an elastomeric nucleus, a rigid polymer layer covering the nucleus, and an elastomeric polymer layer covering the rigid polymer layer, wherein the elastomeric nucleus and elastomeric polymer layer comprise elastomeric polymers having glass transition temperatures of less than 25° C., and the rigid polymer layer comprises at least one polymer having a glass transition temperature of greater than 25° C.

20. A process for preparing the core-shell polymer of claim 11 comprising:
a) emulsion polymerizing at least two monomers having organic carbon derived from biomass to form an emulsion of the core-shell polymer; and
b) drying the emulsion to form a powder.

21. A method of modifying impact strength properties of a polymer material comprising adding to the polymer material the core-shell polymer of claim 11.

22. A composition comprising:
a) at least one polymer matrix; and
b) from 0.5% to 77% by weight of a core-shell polymer of claim 11.

23. The composition of claim 22, wherein the polymer matrix is selected from poly(vinyl chloride) polymers, polyesters, polystyrenes, polycarbonates, polyethylenes, polymethyl methacrylates, (meth)acrylic copolymers, poly(methyl methacrylate-co-ethyl acrylate) thermoplastics, polyalkylene terephthalates, poly(vinylidene fluoride) polymers, poly(vinylidene chloride) polymers, semicrystalline polyamides, amorphous polyamides, semicrystalline copolyamides, amorphous copolyamides, polyetheramides, polyesteramides, and copolymers of styrene or acrylonitrile (SAN), or mixtures thereof.
